(19) United States
(12) Patent Application Publication
(10) Pub. No.: US 2025/0014125 A1
(43) Pub. Date: Jan. 9, 2025

(54) METHODS AND INTERNET OF THINGS SYSTEMS FOR SMART GAS INSPECTION SUPERVISION

(71) Applicant: CHENGDU QINCHUAN IOT TECHNOLOGY CO., LTD., Chengdu (CN)

(72) Inventors: Zehua SHAO, Chengdu (CN); Junyan ZHOU, Chengdu (CN); Yunbai CHEN, Chengdu (CN)

(73) Assignee: CHENGDU QINCHUAN IOT TECHNOLOGY CO., LTD., Chengdu (CN)

(21) Appl. No.: 18/892,506

(22) Filed: Sep. 22, 2024

(30) Foreign Application Priority Data
Aug. 7, 2024 (CN) 202411079320.0

(51) Int. Cl. G06Q 50/06; G06Q 10/0631; G06Q 30/018; G06Q 50/26

(52) U.S. Cl. CPC G06Q 50/06; G06Q 10/063112; G06Q 30/018; G06Q 50/26

(57) ABSTRACT

Disclosed is a method for smart gas inspection supervision, comprising: evaluating an inspection matching degree between an inspector and an inspection device based on inspection record data and operation data; determining a task assignment parameter and a training parameter for the inspector based on a matching degree set; adjusting a first acquisition ratio of the inspection record data by a gas company inspector object platform, and a second acquisition ratio of the operation data by the gas company device object platform based on the task assignment parameter and the training parameter; adjusting a gas collection frequency of a gas sensor device, and a gas upload frequency of the gas sensor device based on task execution result; and generating an adjustment instruction based on an adjustment amount of the gas collection frequency and an adjustment amount of the gas upload frequency, and sending the adjustment instruction to a gas sensor device.

### CROSS-REFERENCE TO RELATED APPLICATION

This application claims priority to Chinese application No. 202411079320.0, filed on Aug. 7, 2024, the entire contents of which are incorporated herein by reference.

### TECHNICAL FIELD

The present disclosure relates to a technical field of the Internet of Things (IoT), and in particular, to a method and an Internet of Things (IoT) system for smart gas inspection supervision.

### BACKGROUND

With the development of the gas industry, how to inspect the gas pipeline network has become a problem that can not be ignored. Because of the variety of gas devices in the gas pipeline network and stations, if an inspector inspects all gas devices and pipelines along the line, it is difficult to ensure that all devices and pipelines are inspected in place; if different inspectors specialize in inspecting a certain type of device, the number of personnel required is too large, resulting in a large waste of human resources, and the inspection efficiency is low.

Chinese patent application No. CN109767513B proposes a method for pipeline network device inspection, which generates inspection recommendation information based on data on surrounding road traffic conditions and pre-stored data on surrounding environmental conditions, static health condition data of the device, data on the distribution of high-consequence areas of the line, and data on hidden danger status along the line. The inspectors may perform inspections according to the inspection recommendation information. However, the method does not take into account the different degrees of familiarity of the inspectors with different devices, and the inspection efficiency needs to be improved.

Therefore, it is necessary to provide a method and an Internet of Things (IoT) system for smart gas inspection supervision, which may improve the inspection efficiency as much as possible while ensuring inspection efficiency, and ensuring normal and safe operation of the gas pipeline network.

### SUMMARY

In order to solve the problem of assigning inspection tasks to inspectors to improve inspection efficiency while ensuring the inspection effect, the present disclosure provides a method and an Internet of Things (IoT) system for smart gas inspection supervision.

The present disclosure provides a method for smart gas inspection supervision. The method is executed by a processor of a gas company management platform of an Internet of Things (IoT) system for smart gas inspection supervision. The method includes: collecting inspection record data based on a gas company inspector object platform, the inspection record data being stored in a data storage center of the gas company management platform; obtaining operation data of at least one inspection device based on a gas company device object platform, the operation data being stored in the data storage center of the gas company management platform, and the at least one inspection device including at least one type of the inspection device; for a type of inspection device, evaluating an inspection matching degree between an inspector and the inspection device based on the inspection record data and the operation data; determining a task assignment parameter and a training parameter for the inspector based on a matching degree set, the matching degree set including the inspection matching degree between the inspector and the at least one type of inspection device; adjusting a first acquisition ratio of the inspection record data by the gas company inspector object platform, and a second acquisition ratio of the operation data by the gas company device object platform based on the task assignment parameter and the training parameter; sending a result of task execution of the inspector to a government supervision management platform; evaluating inspection quality of different gas companies by the government supervision management platform based on the result of task execution, and adjusting, based on the inspection quality, an inspection supervision parameter of the government supervision management platform for the different gas companies, a gas collection frequency of a gas sensor device, and a gas upload frequency of the gas sensor device; and generating an adjustment instruction based on an adjustment amount of the gas collection frequency and an adjustment amount of the gas upload frequency, and sending the adjustment instruction to the gas sensor device.

The present disclosure provides an Internet of Things (IoT) system for smart gas inspection supervision. The IoT system includes a gas company management platform, a gas company sensor network platform, a gas company object platform, a government supervision user platform, a government supervision service platform, a government supervision management platform, a government supervision sensor network platform, and a government supervision object platform, the gas company object platform including a gas company inspector object platform and a gas company device object platform, and the gas company management platform including a data processing sub-platform and a data storage center; and the IoT system is configured to: collect inspection record data based on the gas company inspector object platform, the inspection record data being stored in the data storage center of the gas company management platform; obtain operation data of at least one inspection device based on the gas company device object platform, the operation data being stored in the data storage center of the gas company management platform, and the at least one inspection device including at least one type of the inspection device; for a type of inspection device, evaluate an inspection matching degree between an inspector and the inspection device based on the inspection record data and the operation data; determine a task assignment parameter and a training parameter for the inspector based on a matching degree set, the matching degree set including an inspection matching degree between the inspector and at least one type of inspection device; adjust a first acquisition ratio of the inspection record data by the gas company inspector object platform and a second acquisition ratio of the operation data by the gas company device object platform based on the task assignment parameter and the training parameter; send a result of task execution of the inspector to the government supervision management platform; evaluate inspection quality of different gas companies by the government supervision management platform based on the result of task execution, and adjust, based on the inspection quality, an inspection supervision parameter of the government supervision management platform for the different gas companies, a gas collection frequency of a gas sensor device, and a gas upload frequency of the gas sensor device; and generate an adjustment instruction based on an adjustment amount of the gas collection frequency and an adjustment amount of the gas upload frequency, and send the adjustment instruction to the gas sensor device.

The present disclosure provides a non-transitory computer-readable storage medium, comprising a set of instructions, wherein when a computer reads the computer instructions in the storage medium, a method for smart gas inspection supervision is implemented.

Beneficial effects brought about by the present disclosure include but are not limited to the following: utilizing the IoT system for smart gas inspection supervision for collecting inspection-related data, judging and determining whether the inspector is capable of performing the inspection task, and scientifically deploying a correspondence relationship between the inspector and the inspection device can improve the inspection efficiency and ensure the inspection quality. Additionally, combining the government supervision platform and the real-time supervision of the inspection situation can improve the enthusiasm for inspection and protect the normal operation of a gas pipeline network.

### BRIEF DESCRIPTION OF THE DRAWINGS

FIG. 1 is a schematic diagram illustrating an exemplary platform structure of an Internet of Things (IoT) system for smart gas inspection supervision according to some embodiments of the present disclosure;

FIG. 2 is a flowchart illustrating a method for smart gas inspection supervision according to some embodiments of the present disclosure;

FIG. 3 is a flowchart illustrating an exemplary process for determining an inspection accuracy according to some embodiments of the present disclosure;

FIG. 4 is a flowchart illustrating an exemplary process for determining a task assignment parameter according to some embodiments of the present disclosure; and

FIG. 5 is a schematic diagram illustrating an exemplary process for determining an inspection score based on an inspection analysis model according to some embodiments of the present disclosure.

### DETAILED DESCRIPTION

In order to more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and it is possible for those skilled in the art to apply the present disclosure to other similar scenarios based on the accompanying drawings without creative labor.

It should be understood that the use of “system”, “device”, “unit”, and/or “module” in the present disclosure is a method way to distinguish different components, elements, parts, sections, or assemblies at various levels. However, if other terms may achieve the same purpose, they may replace the mentioned terms.

As shown in this specification the present disclosure and the claims, unless the context explicitly suggests otherwise, the words “one”, “a”, “an”, and/or “the” are not limited to the singular but may also include the plural. Generally, the terms “comprising” and “including” only indicate the inclusion of the steps and elements that have been clearly identified, and these steps and elements do not constitute an exclusive list, the method or device may also include other steps or elements.

Flowcharts are used in the present disclosure to illustrate the operations performed by the systems of the embodiments of the present disclosure. It should be understood that the preceding or following operations are not necessarily executed in precise sequence. Instead, various steps may be processed in reverse order or simultaneously. Additionally, other operations may be added to these processes, or one or several steps or operations may be removed from these processes.

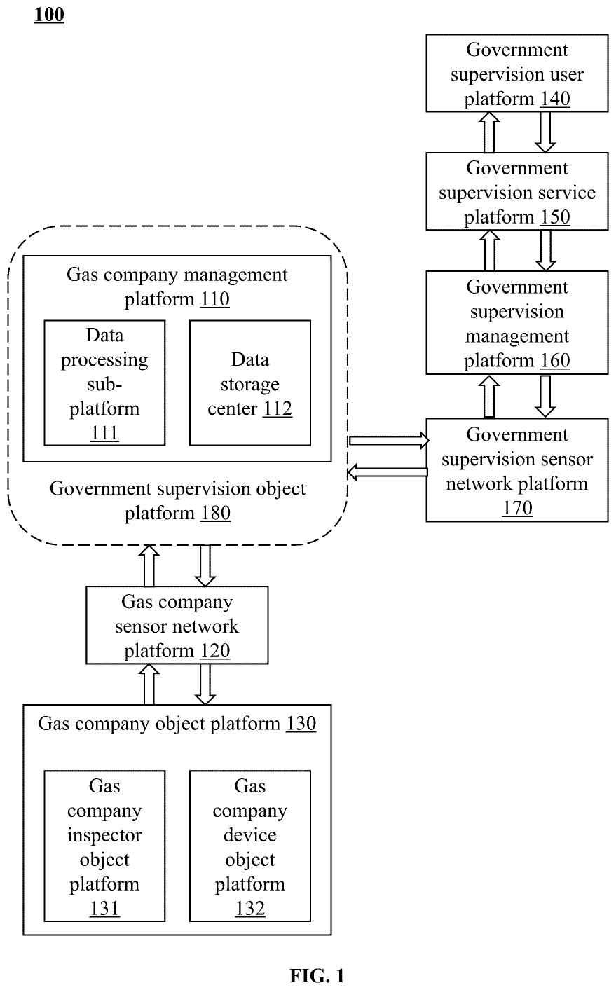

FIG. 1 is a schematic diagram illustrating an exemplary platform structure of an Internet of Things (IoT) system for smart gas inspection supervision according to some embodiments of the present disclosure. The Internet of Things system for smart gas inspection supervision (hereinafter referred to as an “IoT system”) according to some embodiments of the present disclosure may be described in detail below. It should be noted that the following embodiments are used only for explaining the present disclosure and do not constitute a limitation of the present disclosure.

In some embodiments, as shown in FIG. 1, an IoT system 100 for smart gas inspection supervision includes a gas company management platform 110, a gas company sensor network platform 120, a gas company object platform 130, a government supervision user platform 140, a government supervision service platform 150, a government supervision management platform 160, a government supervision sensor network platform 170, and a government supervision object platform 180.

The gas company management platform 110 is configured to coordinate and harmonize the linkage and collaboration between functional platforms, aggregate all information of the IoT system 100, and serve as a platform for providing functions of sensing management and control management for the IoT system 100.

In some embodiments, the gas company management platform 110 includes a data processing sub-platform 111 and a data storage center 112.

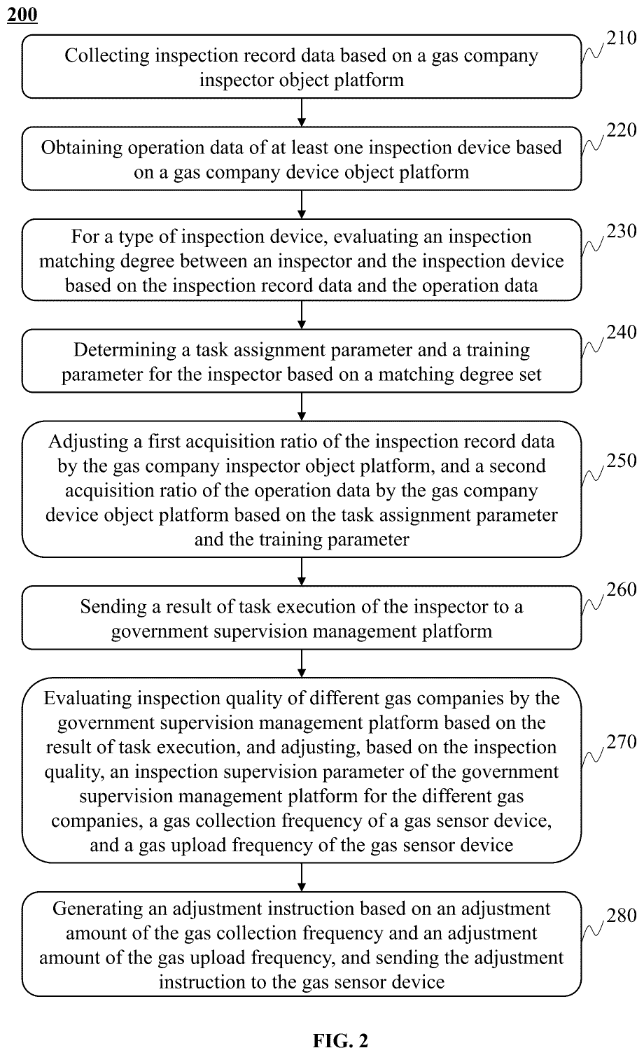

The data processing sub-platform 111 may be configured to process data related to the IoT system 100 for smart gas inspection supervision. For example, the data processing sub-platform 111 may evaluate an inspection matching degree between an inspector and an inspection device based on inspection record data and operation data. Detailed descriptions of evaluating the inspection matching degree can be found in FIG. 2 and the related descriptions thereof.

In some embodiments, the data storage center 112 may be configured to store data and/or instructions related to the IoT system 100 for smart gas inspection supervision. For example, the data storage center 112 may store the inspection record data. In some embodiments, the data storage center 112 may interact with the gas company sensor network platform 120. For example, the data storage center 112 may send a task assignment parameter and a training parameter to the gas company sensor network platform 120, respectively, to adjust a first acquisition ratio of the inspection record data by the gas company inspector object platform 131, and a second acquisition ratio of the operation data by the gas company device object platform 132.

The gas company sensor network platform 120 may be a functional platform configured to manage sensing communication. In some embodiments, the gas company sensor network platform 120 may realize the functions of sensing information communication and controlling information communication.

In some embodiments, the gas company sensor network platform 120 may be configured to interact with the gas company management platform 110 and the gas company object platform 130.

The gas company object platform 130 may be a functional platform configured to generate the sensing information and execute the controlling information. In some embodiments, the gas company object platform 130 may include a gas company inspector object platform 131 and a gas company device object platform 132.

The gas company inspector object platform 131 may be a platform for interacting with the inspector. In some embodiments, the gas company inspector object platform 131 may be configured as a terminal device.

The gas company device object platform 132 may monitor and generate the operation data of the inspection device. In some embodiments, the gas company device object platform 132 may be configured for various types of gas devices, sensors, or the like.

In some embodiments, the government supervision user platform 140 may be referred to as a user platform. In some embodiments, the gas company management platform 110 may obtain inspection quality of different gas companies based on the government supervision management platform 160. In some embodiments, the government supervision management platform 160 may evaluate the inspection quality of different gas companies based on a result of task execution, and adjust, based on the inspection quality, an inspection supervision parameter of the government supervision management platform 160 for the different gas companies, a gas collection frequency of a gas sensor device, and a gas upload frequency of the gas sensor device; and generate an adjustment instruction based on an adjustment amount of the gas collection frequency and an adjustment amount of the gas upload frequency, and send the adjustment instruction to the gas sensor device. Detailed descriptions of the gas sensor device may be referred to relevant descriptions of FIG. 2.

In some embodiments, the gas company management platform 110 may interact bi-directionally with the government supervision sensor network platform 170. For example, the gas company management platform 110 may send the result of task execution of the inspector to the government supervision management platform 160 via the government supervision sensor network platform 170.

In some embodiments of the present disclosure, the IoT system 100 for smart gas inspection supervision may form a closed loop of information operation between the gas company management platform 110 and the government supervision object platform 180, and operate in a coordinated and regular manner under the unified management of the data processing sub-platform 111 of the gas company management platform 110, thereby realizing the informatization and intelligence of the inspection of a gas pipeline network.

FIG. 2 is a flowchart illustrating a method for smart gas inspection supervision according to some embodiments of the present disclosure. As shown in FIG. 2, a process 200 includes following steps.

Step 210, collecting inspection record data based on a gas company inspector object platform. In some embodiments, the step 210 may be performed by a processor in a gas company management platform.

The inspection record data is data related to inspection. The inspection record data may include an inspection time, an inspection device, an inspection result, or the like. The inspection time is a time when an inspection is performed.

The inspection device is an object being inspected. The inspection device may include at least one of a gas pipeline, a gas pipeline network, a device in a gas field station, or the like.

The inspection result is a summarized record of the inspection. The inspection result may include an operation situation of a device, a fault situation of the device, or the like. For example, whether the device is operating normally, what a fault occurs, or the like.

In some embodiments, the processor may collect the inspection record data based on the gas company inspector object platform and store the inspection record data in a data storage center of the gas company management platform. For example, the gas company inspector object platform may be configured as a terminal device. For each inspection device inspected by the inspector, a condition of each inspection device is recorded at the terminal device as inspection record data of each inspection device. The terminal device is a device configured to record the inspection record data. The terminal device may include a cell phone, a computer, or the like. The inspection record data may be uploaded by the terminal device to the data storage center of the gas company management platform.

Step 220, obtaining operation data of at least one inspection device based on a gas company device object platform. In some embodiments, the step 220 may be performed by the processor of the gas company management platform.

The operation data refers to data generated by the inspection device during an operation. The operation data may include operation log data saved by the inspection device itself and data from a sensor used to monitor an operation status of the inspection device. For example, data saved during an operation of a pressure regulator, data of a pressure sensor configured to monitor a pressure within a gas pipeline, or the like. The inspection devices may include different types. For example, the types of the inspection device may include a gas device in a gas pipeline, a gas device in a gas pipeline network, a gas device in a gas field station, or the like. The operation data is stored in the data storage center of the gas company management platform.

In some embodiments, the processor may obtain the operation data of the at least one inspection device based on the gas device of the gas company device platform, various types of sensors, or the like. The sensor may include a pressure sensor, or the like.

Step 230, for a type of inspection device, evaluating an inspection matching degree between an inspector and the inspection device based on the inspection record data and the operation data. In some embodiments, step 230 may be performed by the processor of the gas company management platform.

The inspector is a person who performs an inspection. The inspector may be a plurality.

The inspection matching degree is a parameter that characterizes a suitability degree between the inspector and different types of inspection devices. In some embodiments, the lower the frequency and the later the inspection device appears to have an operation abnormality after being inspected by the inspector, the higher the inspection matching degree.

In some embodiments, the processor may determine the inspection matching degree based on the inspection record data and the operation data according to an operation abnormality of each type of inspection device after being inspected by the inspector. The processor may determine, based on the inspection record data, types of inspection devices that have been inspected by the processor, and based on the operation data, count the frequency and time of operation abnormality of each type of the inspection device during a first preset period after being inspected by the inspector. The operation abnormality may include a fault or a fault to operate in accordance with a preset situation, or the like. The first preset period may be preset manually. For example, 7 days. The processor may query a first preset table based on the frequency and time of operation abnormality of each type of the inspection device during the first preset period after being inspected by the inspector, to determine an inspection matching degree between the inspector and each type of the inspection device. The first preset table includes a correspondence between the frequency and time of operation abnormality during the first preset period and the inspection matching degree of each type of the inspection device after being inspected by the inspector. The first preset table may be determined based on a priori experience or historical data.

In some embodiments, the processor may evaluate the inspection accuracy of the inspector regarding the inspection device based on the inspection record data and the operation data, and determine the inspection matching degree based on the inspection accuracy and an accuracy threshold of the inspection device.

The inspection accuracy is a degree to which an inspection result matches an actual situation. The higher the inspection accuracy, the more consistent the inspection result is with the actual situation.

In some embodiments, after an inspection, a gas company may assign maintenance personnel to repair an inspection device that has an operation abnormality. The processor may determine the inspection accuracy based on a conformity degree between an actual fault situation uploaded by the maintenance personnel and a fault situation in the inspection data of the inspector. The actual fault situation is an actual abnormality of a type of inspection device. For example, an actual degree of a fault, a reason why the fault occurred, or the like. The processor may construct an actual vector based on the actual fault situation and an element of the actual vector includes a fault situation. The processor may construct a reference vector based on the inspection result and an element of the reference vector includes the fault situation. The processor may determine the inspection accuracy by calculating a vector distance between the actual vector and the reference vector through a second preset table. The second preset table includes a correspondence between a vector distance between an actual vector and a reference vector corresponding to each type of the inspection device and an inspection accuracy corresponding to each type of the inspection device. The second preset table may be determined based on a priori experience or historical data. In some embodiments, the vector distance between the actual vector and the reference vector may be negatively correlated with the inspection accuracy.

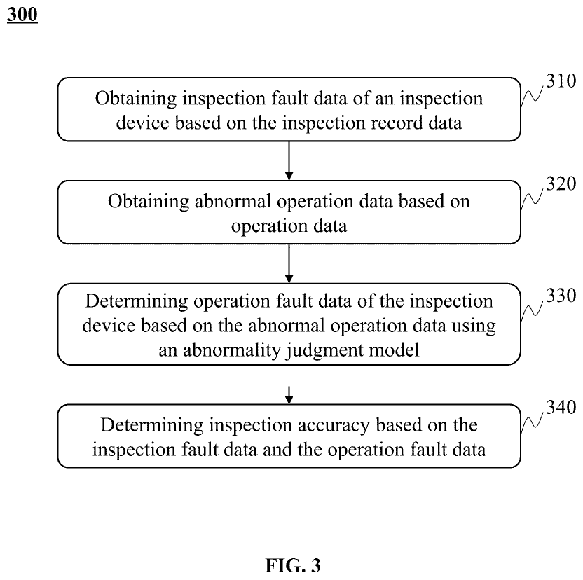

In some embodiments, the processor may also determine the inspection accuracy based on inspection fault data and the operation fault data, and details thereof can be found in FIG. 3 and its relevant descriptions.

The accuracy threshold is a basic accuracy requirement for the inspection device. The accuracy threshold may be preset based on a priori experience or historical data. In some embodiments, the accuracy threshold corresponding to different types of inspection devices may be different. In some embodiments, the accuracy threshold corresponding to different types of inspection devices may be different, and the accuracy threshold corresponding to a same type of inspection devices may be the same. In some embodiments, the accuracy threshold of the inspection device is not set as high as appropriate. If the accuracy threshold is too high, it may result in too few inspectors ultimately meeting a requirement, and too few inspectors can perform an inspection task, which fails to guarantee the completion of the inspection task. For example, the accuracy threshold may be appropriately lowered for an inspection device that is not a critical component.

In some embodiments, the processor may determine the inspection matching degree by querying a third preset table based on a difference between an inspection accuracy and an accuracy threshold of each type of the inspection device. The third preset table includes a correspondence between the difference between the inspection accuracy and the accuracy threshold of each type of the inspection device and the inspection matching degree. The third preset table may be determined based on a priori experience or historical data. In some embodiments, the difference between the inspection accuracy and the accuracy threshold of the inspection device is positively correlated with the inspection matching degree.

In some embodiments, the processor may determine, based on the inspection record data, a distribution of inspection durations of the inspector on a plurality of inspection devices, determine an inspection efficiency based on the distribution of inspection durations, and determine the inspection matching degree based on the inspection efficiency and the inspection accuracy.

The distribution of inspection durations is a count of durations used to inspect each inspection device. In some embodiments, the processor may obtain, based on the inspection record data, an inspection duration used by the inspector to inspect each inspection device to obtain the distribution of inspection durations. The distribution of inspection durations may characterize an inspection duration used by the inspector on different inspection devices.

The inspection efficiency is data reflecting how quickly and/or evenly the inspector inspects the inspection device. In some embodiments, the processor may determine the inspection efficiency based on a statistical value of a distribution of inspection durations of inspection devices of a same type. The statistical value may include a mean value and/or a variance. For example, the processor may determine the inspection efficiency by querying a fourth preset table based on mean values of inspection durations corresponding to different types of inspection devices. The fourth preset table includes a correspondence between the mean value of the inspection durations and the inspection efficiency. The fourth preset table may be determined based on a priori experience or historical data. In some embodiments, the more evenly (i.e., the smaller the variance) and the smaller the mean value of the distribution of inspection durations of inspection devices of the same type, the more the inspection efficiency.

In some embodiments, the processor may determine the inspection efficiency based on a distribution of inspection devices, a distribution of inspection durations, and an inspection accuracy of inspection devices of the same type using an efficiency model.

Understandably, the more decentralized the distribution of inspection devices, the more time-consuming it may be for the inspector to complete the inspection, and it is not convenient for the inspector to centralize the analysis of the inspection devices, which is not conducive to the search for common causes. At this time, a slightly longer inspection duration does not indicate a low inspection efficiency. Therefore, the inspection efficiency is related to the distribution of inspection devices. It is natural that an inspection duration may be a little longer when the inspection accuracy is guaranteed to be high, so the inspection efficiency needs to be determined in conjunction with the inspection accuracy.

The distribution of inspection devices refers to a geographic distribution of inspection devices of the same type. The distribution of inspection devices may include a distance between inspection devices, a distribution density, or the like. In some embodiments, the processor may obtain the distribution of inspection devices by extracting a gas pipeline network.

The efficiency model is a model used to determine the inspection efficiency. The efficiency model is a machine learning model, for example, a Deep Neural Networks (DNN) model, or the like.

Inputs to the efficiency model may include the distribution of inspection devices, the distribution of inspection durations, and the inspection accuracy, and an output of the efficiency model may include the inspection efficiency.

In some embodiments, the processor may obtain the efficiency model by training the efficiency model with a large number of first samples with a first label. The first sample may include a sample distribution of inspection devices, a sample distribution of inspection durations, and a sample inspection accuracy of sample inspection devices of a same type. The processor may obtain a mean value of inspection durations of a certain batch of inspection devices whose fault rates are lower than a fault threshold after being inspected in the historical data, and based on the mean value, determine the inspection efficiency, by querying a fifth preset table, as the first label. The fault rate is a probability that inspection devices of a same type that have faults among all inspection devices during a second preset period. The second preset period may be preset manually. The fault threshold is a critical value for a fault rate within an acceptable range. The fault threshold may be based preset manually. Understandably, the processor may select inspection efficiency determined from historical data with a low fault rate as the first label, which ensures that the inspection efficiency is determined based on the premise that the inspector has carefully inspected the inspection device, so that a determined inspection efficiency is more in line with an actual situation, avoiding the possibility of judging the inspection efficiency only based on the inspection duration (i.e., determining the inspection efficiency based on inspection durations of a certain batch of inspection devices with random fault rates), or the like, thereby improving the objectivity of the determined inspection efficiency. For example, although the inspector took a shorter time to complete the inspection task, a subsequent high fault rate of the inspection device indicates that the inspector did not complete the inspection task seriously, and may not represent that the inspector has high inspection efficiency.

In some embodiments, the processor may input the sample distribution of inspection devices, the sample distribution of inspection durations, and the sample inspection accuracy into an initial efficiency model, construct a loss function based on an output of the initial efficiency model and the first label, and based on the loss function, update parameters of the initial efficiency model, then obtain a trained efficiency model. In some embodiments, the processor may iteratively update the parameters of the initial efficiency model based on a plurality of first samples to make the loss function satisfy a preset condition. For example, the loss function converges, or a value of the loss function is less than a preset value. A model training is completed when the loss function satisfies the preset condition, then the trained efficiency model is obtained.

Some embodiments of the present disclosure predict the inspection efficiency using a machine learning model, which not only improves the accuracy of an output result, but also avoids judging the inspection efficiency only based on inspection durations by selecting the historical data with a lower fault rate for determining the first label, improving the objectivity of the output result, and making it easier to obtain a more accurate inspection matching degree subsequently.

In some embodiments, the processor may determine the inspection matching degree based on the inspection efficiency and the inspection accuracy by weighted calculation. Weights of the inspection efficiency and the inspection accuracy may be determined based on a priori experience or historical data. In some embodiments, a weight corresponding to the inspection accuracy is larger than a weight corresponding to the inspection efficiency to ensure normal gas supply and gas safety.

Some embodiments of the present disclosure determine the inspection matching degree based on the inspection efficiency and the inspection accuracy, which takes into account the influence of the inspection efficiency and the inspection accuracy on the inspection matching degree, respectively, ensures as much as possible that the inspection matching degree is accurate and adaptive, and ensures the rationality of the inspection supervision.

Some embodiments of the present disclosure determine the inspection accuracy based on the inspection record data and the operation data, and then further determine the inspection matching degree based on the inspection accuracy, which evaluates a consistent degree between the inspection result and the actual situation, and guarantees the authenticity and reliability of a matching degree between the inspector and the inspection device.

Step 240, determining a task assignment parameter and a training parameter for the inspector based on a matching degree set. In some embodiments, step 240 may be performed by the processor of the gas company management platform.

The matching degree set includes an inspection matching degree between the inspector and at least one type of inspection device.

The task assignment parameter is data of an inspection device to which the inspector is assigned to inspect. The task assignment parameter may include a type, a position, a count, or the like, of the inspection device to which the inspector is assigned to inspect. The count of the inspection device to which the inspector is assigned to inspect may be a plurality.

In some embodiments, for each type of inspection device, the processor may assign a type of inspection device based on an inspection matching degree between the type of inspection device and an inspector, and assign the type of inspection device to an inspector with a higher inspection matching degree in accordance with an assignment ratio, thereby determining the task assignment parameter. For example, the processor may rank inspection matching degrees between each inspector and the type of inspection device in a descending order, and assign inspectors ranked in the top three to inspect the type of inspection device in accordance with the assignment ratio. The processor may determine the assignment ratio based on ratios of the inspection matching degrees between the inspectors and the type of inspection device, and assign an inspection task of the type of inspection device to each inspector in accordance with the assignment ratio. The assignment ratio is a ratio of a count of inspection tasks assigned to each inspector. Exemplarily, inspectors A, B, and C are the top three inspectors regarding an inspection matching degree for a type A inspection device, with scores of 10, 15, and 20, respectively, then the assignment ratio is 10:15:20=2:3:4. If at this time, the type A inspection device has 9 devices that need to be inspected, then the inspectors A, B, and C are assigned 2, 3, and 4 type A inspection devices, respectively.

In some embodiments, each inspector may be assigned an inspection task for a plurality of types of inspection devices.

In some embodiments, the processor may, based on the training parameter and a training progress of each inspector, dynamically schedule an inspection task corresponding to a type of inspection device to an inspector who has completed the training content corresponding to the type of inspection device but has a low inspection matching degree during a period in which there is no inspection task scheduled.

In some embodiments, the processor may set an inspection task capacity for each inspector based on historical data of each inspector. The inspection task capacity is a maximum count of inspection tasks that each inspector can handle. When a count of inspection tasks corresponding to an inspector reaches the inspection task capacity, the processor may no longer assign inspection tasks to the inspector.

The training parameter is data related to training an inspector. The training parameter may include training content, a training frequency, and an assessment frequency for the inspector.

In some embodiments, the processor may determine an inspector who has a lower inspection matching degree (e.g., lower than a preset inspection matching degree, and the preset inspection matching degree may be set artificially) for a type of inspection device, and determine training content corresponding to the type of inspection device as training content corresponding to the inspector. In some embodiments, the inspection matching degree is inversely proportional to the training frequency and the assessment frequency, respectively. The training frequency and the assessment frequency may be preset and updated based on a manual process.

In some embodiments, the processor may determine the task assignment parameter based on the matching degree set and a matching degree requirement set, and determine the training parameter based on the matching degree set and the task assignment parameter.

A matching degree requirement is a minimum matching degree used to determine whether an inspector can undertake an inspection task for a particular inspection device or type of inspection device. The matching degree requirement may be preset manually. In some embodiments, the matching degree requirement may be a minimum matching degree for the inspector to undertake an inspection task for a particular type of inspection device in terms of the inspector's ability. In some embodiments, the matching degree requirement may be a minimum matching degree for the inspector to undertake an inspection task for a particular inspection device in terms of the inspector's ability. The matching degree requirement may be expressed numerically.

The matching degree requirement set may include a plurality of matching degree requirements. When the matching degree requirement corresponds to a particular type of inspection device, the matching degree set may include matching degree requirements of each type of inspection device in at least one type of inspection device, and when the matching degree requirement corresponds to a particular inspection device, the matching degree set may include matching degree requirements of each inspection device in at least one inspection device.

In some embodiments, when the matching degree requirement set includes the matching degree requirements of each inspection device in at least one inspection device, the processor may determine the matching degree requirement based on a gas safety impact degree, a gas usage impact degree, and an accuracy threshold of the at least one inspection device.

The gas safety impact degree is a degree to which the inspection device impacts gas safety. In some embodiments, the gas safety impact degree is determined based on the position and historical fault impact of the at least one inspection device.

The historical fault impact is a safety consequence of a historical fault. A fault may include safety incidents such as poisonings, gas leaks, fires, explosions, or the like. Different faults correspond to different safety consequences, and fault impacts of different faults are different, the historical fault impact may be represented by numbers, and the larger the number, the greater the safety consequence of the historical fault. The historical fault impact may be based on preset manually.

In some embodiments, the gas safety impact degree is positively correlated with foot traffic and the historical fault impact, respectively. In some embodiments, the processor may determine the gas safety impact degree, based on foot traffic where the inspection device is located and the historical fault impact through weighted calculation. Weights corresponding to the foot traffic and the historical fault impact may be set manually.

The gas usage impact degree is a degree to which the inspection device impacts gas usage. In some embodiments, the processor may determine the gas usage impact degree through weighted calculation based on a gas flow rate flowing through the inspection device and a count of gas users corresponding to the inspection device. Weights of the gas flow rate flowing through the inspection device and the count of gas users corresponding to the inspection device, respectively, may be preset manually. The count of gas users is a count of users using the inspection device which the gas supply flows through.

In some embodiments, the matching degree requirement is positively correlated with the gas safety impact degree, the gas usage impact degree, and the accuracy threshold. In some embodiments, the processor may determine the matching degree requirement based on the gas safety impact degree, the gas usage impact degree, and the accuracy threshold through weighted calculation. Weights corresponding to the gas safety impact degree, the gas usage impact degree, and the accuracy threshold, respectively, may be preset manually.

Some embodiments of the present disclosure determine the matching degree requirement based on the gas safety impact degree, the gas usage impact degree, and the accuracy threshold, and comprehensively consider an importance level of the inspection device to correspondingly determine the matching degree requirement, and then screen the abilities of the inspectors, which ensures the normal gas inspection and a normal operation of the gas pipeline network.

In some embodiments, the processor may determine an inspection device whose inspection matching degree satisfies the matching degree requirement as an inspection device that may be inspected by the inspector.

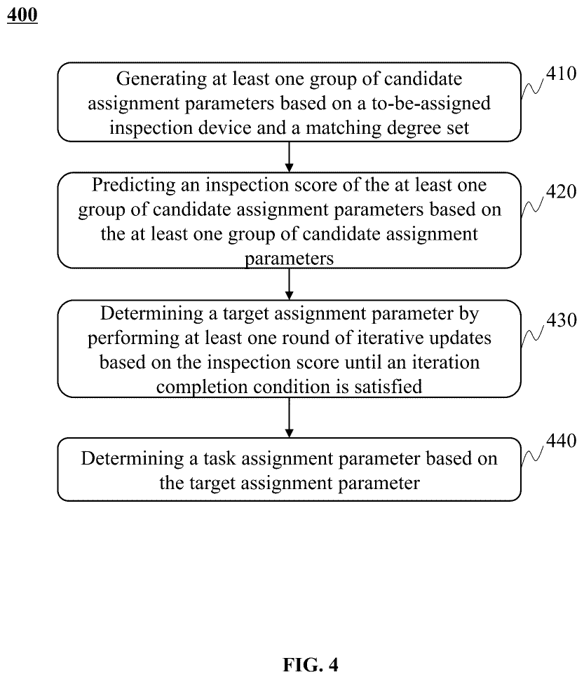

In some embodiments, the processor may assign a to-be-assigned inspection device that is closest to an inspector to the inspector, and determine the task assignment parameter based on an assignment result. Detailed descriptions of the to-be-assigned inspection device can be found in FIG. 4 and related descriptions thereof.

In some embodiments, the training parameter further includes a training duration and a period for completion of training.

The training duration is a duration for which a training is required. In some embodiments, the processor may, based on the inspection matching degree, determine training content corresponding to an inspection device whose inspection matching degree does not satisfy the matching degree requirement as training content needed by the inspector, and based on a difference between the inspection matching degree and a matching degree threshold, determine the training duration of the inspector by querying a sixth preset table. The matching degree threshold may be preset manually. The sixth preset table includes a correspondence between the difference between the inspection matching degree and the matching degree threshold and the training duration. The sixth preset table may be determined based on a priori experience or historical data. In some embodiments, the inspection matching degree is negatively correlated with the training duration.

The period for completion of training is a deadline to complete the training content. In some embodiments, the processor may determine, based on the task assignment parameter, a time point before the inspection of the inspection device corresponding to the training content as the period for completion of training.

Some embodiments of the present disclosure determine the task assignment parameter, based on the matching degree set and the matching degree requirement set, and thus determine the training parameter, which can ensure that the inspection task corresponding to the inspection device is correctly assigned, and that the inspector who has been assigned the inspection task can complete the inspection task with high quality, thereby ensuring the normal operation of the gas pipeline network.

Step 250, adjusting a first acquisition ratio of the inspection record data by the gas company inspector object platform, and a second acquisition ratio of the operation data by the gas company device object platform based on the task assignment parameter and the training parameter. In some embodiments, the step 250 may be performed by the processor of the gas company management platform.

The first acquisition ratio refers to an acquisition ratio of the inspection record data by the gas company inspector object platform. The first acquisition ratio may be preset manually. In some embodiments, for each inspector, the processor may adjust the first acquisition ratio based on the task assignment parameter and the training parameter. The more and more important the training content is, a first acquisition ratio corresponding to inspection record data and operation data corresponding to an inspection device may be appropriately increased to accurately assess the change of the inspector regarding the inspection matching degree of the inspection device which should be seriously trained and exercised. For example, the processor may determine a training importance degree based on an amount and importance of training content, and determine an adjusted first acquisition ratio based on the training importance degree. The training importance degree is a numerical value used to reflect a degree of importance of a training. In some embodiments, the processor may determine the training importance degree by querying a seventh preset table based on the amount and importance of the training content. The seventh preset table may include a correspondence between the amount and importance of the training content and the training importance degree. The seventh preset table may be preset manually.

In some embodiments, the processor may determine the adjusted first acquisition ratio based on a ratio of the inspector to training importance degrees of different inspection devices. For example, if a training importance degree of an inspector A for inspection devices a, b, and c is 2, 3, and 4, respectively, that is, a ratio of training importance degrees for a, b, and c is 2:3:4, then the processor may determine the adjusted first acquisition ratio to be 2:3:4.

The second acquisition ratio is an acquisition ratio of the operation data by the gas company device object platform. The second acquisition ratio may be preset manually. In some embodiments, for each type of inspection device, the processor may adjust the second acquisition ratio based on an average value of inspection matching degrees of inspectors who inspect the type of inspection device. For an inspection device with a lower average value of inspection matching degrees, it is necessary to acquire more operation data to determine whether an inspection situation matches an actual operation situation.

In some embodiments, the processor may determine the second acquisition ratio of the operation data based on a ratio of the inverse of the average value of the inspection matching degrees. For example, the processor may determine the ratio of the inverse of the average value of the inspection matching degrees as a corresponding second acquisition ratio of the operation data.

Step 260, sending a result of task execution of the inspector to the government supervision management platform. In some embodiments, the step 260 may be performed by the processor of the gas company management platform.

The result of task execution is the completion of the inspection task by the inspector. The result of task execution may include an inspection time, an inspection result, and status record data of the inspector for each inspection device. The status record data is data about a status of the inspection device recorded by the inspector. For example, an operation status, an appearance status, or the like. The status record data may be in a form of text, images, videos, or the like.

In some embodiments, the processor may obtain the result of task execution uploaded by the inspector via the terminal device and send the result of task execution to the government supervision management platform.

Step 270, evaluating inspection quality of different gas companies by the government supervision management platform based on the result of task execution, and adjusting, based on the inspection quality, an inspection supervision parameter of the government supervision management platform for the different gas companies, a gas collection frequency of a gas sensor device, and a gas upload frequency of the gas sensor device. In some embodiments, the step 270 may be performed by the government supervision management platform.

The inspection quality is the quality of the completion of the inspection task. For example, an inspection conscientiousness degree, a data perfection degree, or the like.

The inspection conscientiousness degree is a degree of conscientiousness of the inspector when inspecting the inspection device. The inspection conscientiousness degree may be expressed as a number. In some embodiments, the government supervision management platform may determine the inspection quality based on the historical data. For example, the government supervision management platform may determine a reference inspection duration for different types of inspection devices based on a historical inspection record, and calculate a difference between an inspection duration in the result of task execution and the reference inspection duration, and if the difference is less than a reference time threshold, then the inspection duration is too short, and it is judged that the inspection conscientiousness degree of the inspector is insufficient. The reference inspection duration corresponding to each type of inspection device may be an average value of each inspection duration in the historical inspection record. The reference time threshold is a maximum value within an acceptable range of the difference between the inspection duration in the result of task execution and the reference inspection duration. The reference time threshold may be preset manually. The government supervision management platform may determine the inspection conscientiousness degree by querying an eighth preset table based on the difference between the inspection duration in the result of task execution and the reference inspection duration. The eighth preset table may include a correspondence between the difference between the inspection duration in the result of task execution and the reference inspection duration and the inspection conscientiousness degree. The eighth preset table may be determined based on a priori experience or historical data.

The data perfection degree refers to the completeness of data uploaded by the inspector after completing the inspection task. In some embodiments, the government supervision management platform may identify whether the data uploaded by the inspector is perfect or not based on a list of data requirements. The list of data requirements refers to a preset list of data required to be uploaded. For example, the list of data requirements may include photos of the exterior of the inspection device, videos of operation of the inspection device, photos of fault position of the inspection device, text description, or the like. In some embodiments, the data perfection degree may be negatively correlated with an amount of data missed by the inspector. For example, the government supervision management platform may determine the inverse of the amount of data missed by the inspector as the data perfection degree. When the amount of data missed by the inspector is 0, the data perfection degree may be set to 2.

In some embodiments, the government supervision management platform determines the inspection quality by weighted calculation based on the inspection conscientiousness degree and the data perfection degree. Weights corresponding to the inspection conscientiousness degree and the data perfection degree, respectively, may be preset manually.

The inspection supervision parameter is a parameter that supervises the result of task execution for different gas companies. The inspection supervision parameter may include a supervision frequency, a supervision ratio, or the like.

The supervision frequency is a frequency with which the government supervision management platform supervises the results of task execution for different gas companies. The supervision ratio is a ratio of the result of task execution of different gas companies supervised by the government supervision management platform.

In some embodiments, the government supervision management platform may adjust a preset inspection supervision parameter based on the inspection quality to determine the inspection supervision parameter. For example, if a count of inspection devices whose inspection quality does not satisfy a quality requirement exceeds a low-quality ratio threshold in a gas company, a preset inspection supervision parameter for the gas company needs to be appropriately adjusted. The quality requirement is a minimum requirement that needs to be ensured for the inspection quality. The low-quality ratio threshold is a maximum value of a ratio of inspection devices whose inspection quality does not satisfy the quality requirement to all inspection devices in the gas company. The quality requirement and the low-quality ratio threshold may be preset manually.

The gas collection frequency is a frequency at which gas data corresponding to a plurality of inspection devices is collected. The gas data may include operation data of a gas device, air pressure and flow rate of gas passing through the inspection device, or the like.

The gas upload frequency is a frequency of uploading gas data to the gas company management platform or the government supervision management platform.

In some embodiments, the government supervision management platform may determine the gas collection frequency and the gas upload frequency based on an overall situation of inspection quality of the gas company by querying a ninth preset table.

The overall situation of inspection quality may be a statistical value corresponding to the inspection quality of all inspection devices inspected by the gas company. For example, an average value, a plurality, or the like.

The ninth preset table includes a correspondence between the overall situation of inspection quality and the gas collection frequency and the gas upload frequency. The ninth preset table may be determined based on a priori experience or historical data.

In some embodiments, the government supervision management platform may adjust the gas collection frequency and the gas upload frequency via the gas sensor device. The gas sensor device may be connected to the inspection device, and a gateway device of a sensor that monitors the inspection device, for example, a gas company sensor network platform. The gas sensor device may control the inspection device and/or the sensor to collect gas data or upload the gas data to the government supervision management platform based on the gas collection frequency and the gas upload frequency.

Step 280, generating an adjustment instruction based on an adjustment amount of the gas collection frequency and an adjustment amount of the gas upload frequency, and sending the adjustment instruction to the gas sensor device. In some embodiments, the step 280 may be performed by the government supervision management platform.

The adjustment instruction is a computer instruction that controls the gas sensor device to adjust the gas collection frequency and the gas upload frequency. The adjustment instruction may include an adjustment amount for the gas collection frequency and an adjustment amount for the gas upload frequency.

Some embodiments of the present disclosure collect inspection-related data through the Internet of Things (IoT) system for smart gas inspection supervision and determine whether the inspector is capable of performing the inspection task, scientifically deploying a correspondence between the inspector and the inspection device, which may improve the inspection efficiency and guarantee the inspection quality. At the same time, combining the government supervision platform enables real-time supervision of an inspection situation, improves the enthusiasm for inspection, and guarantees the normal operation of the gas pipeline network.

FIG. 3 is a flowchart illustrating an exemplary process for determining an inspection accuracy according to some embodiments of the present disclosure. As shown in FIG. 3, a process 300 includes following steps. In some embodiments, the process 300 may be executed by a processor of a gas company management platform.

Step 310, obtaining inspection fault data of an inspection device based on inspection record data.

The inspection fault data refers to data on a fault situation found during an inspection. In some embodiments, the inspection fault data may include data such as a fault position, a fault degree, an impact degree on gas supply and gas safety, or the like.

In some embodiments, the processor may filter the inspection record data to obtain the inspection fault data.

Step 320, obtaining abnormal operation data based on operation data.

The abnormal operation data is operation data outside an interval of reference operation data, including pressure abnormal operation data, flow rate abnormal operation data, or the like. The interval of reference operation data is a reference interval in which the operation data remains normal, and intervals of reference operation data of different inspection devices may be set based on historical data. In some embodiments, the processor may compare the operation data with the interval of reference operation data, and determine the operation data outside the interval of reference operation data as the abnormal operation data. For example, an interval of reference pressure for a gas pipeline is in a range of 0.2 MPa to 0.4 MPa, and the processor identifies data as the abnormal operation data if pressure data of the gas pipeline is 0.1 MPa.

Step 330, determining operation fault data of the inspection device based on the abnormal operation data using an abnormality judgment model.

The operation fault data refers to fault data obtained by judging based on the abnormal operation data in the operation data. In some embodiments, a type of the operation fault data may be the same as a type of the inspection fault data, as described above.

The abnormality judgment model is a model used to determine the operation fault data of the inspection device. In some embodiments, the abnormality judgment model may be a Deep Neural Network (DNN) model, or the like.

Inputs to the abnormality judgment model may include the abnormal operation data, the interval of reference operation data, and data of the inspection device, and an output may be the operation fault data.

The data of inspection device is data related to the inspection device. In some embodiments, the data of inspection device includes a type, a position, a gas flow rate, or the like, of the inspection device.

In some embodiments, the processor may obtain the abnormality judgment model by training the abnormality judgment model with a large number of second samples with a second label. For example, the processor may input the second sample into an initial abnormality judgment model, construct a loss function based on an output of the initial abnormality judgment model and the second label, and based on the loss function, update parameters of the initial abnormality judgment model to obtain a trained abnormality judgment model.

The second sample may include sample abnormal operation data, sample reference operation data, and sample data of inspection device. The second sample may be determined based on historical data. The second label may be actual fault data corresponding to the second sample. The second label may be obtained based on data on an actual repair performed on the inspection device.

In some embodiments, the processor may iteratively update the parameters of the initial abnormality judgment model based on a manner such as a gradient descent manner to enable the loss function to satisfy a preset condition. For example, the loss function converges, or a value of the loss function is less than a preset value. A model training is completed when the loss function satisfies the preset condition, and the trained abnormality judgment model is obtained.

Step 340, determining inspection accuracy based on the inspection fault data and the operation fault data.

In some embodiments, the processor may determine a compliance degree based on a similarity between the inspection fault data and the operation fault data, or a percentage of matched data in the inspection fault data and the operation fault data. Further, the processor may determine the inspection accuracy by calculating an average value of compliance degrees between inspection fault data and operation fault data of a plurality of inspection devices of a same type. For example, the processor may vectorize the inspection fault data and the operation fault data to obtain the similarity between the inspection fault data and the operation fault data by calculating a distance between vectors. Elements of the vectors include a fault position, a fault degree, an impact degree on the gas supply and gas safety, e.g., vectors of the inspection fault data may be [(fault position 1, fault degree 1, impact degree 1 on the gas supply, impact degree 1 on the gas safety), (fault position 2, fault degree 2, impact degree 2 on the gas supply, impact degree 2 on the gas safety)], or the like. The distance between vectors includes but is not limited to cosine distance, Euclidean distance, or the like, and the distance is negatively correlated with the similarity. Exemplarily, the processor may determine the inverse of the distance between the vectors as the similarity between the inspection fault data and the operation fault data. In some embodiments, the matched data in the inspection fault data and the operation fault data is data that the inspection fault data agrees with the operation fault data. The processor may count a count of the matched data, and count a percentage of the count of the matched data to a total count of data to determine the percentage of the matched data. The count of the matched data refers to a count of fault locations whose impact degree of fault location and fault degree on the gas supply and gas safety in the inspection fault data and the operation fault data are all consistent. The total count of data refers to an average value of a count of fault locations in the inspection fault data and a count of fault locations in the operation fault data.

In some embodiments, the inspection accuracy is also correlated to a fault concealment depth and a gas flow rate of the plurality of inspection devices.

The fault concealment depth is a degree of difficulty for the inspector to directly observe the fault location. The deeper the fault concealment depth is, the more difficult it is for the inspector to directly observe the fault location. The fault concealment depth may be expressed as a number in a range of 0 and 10.

In some embodiments, the inspector may determine the fault concealment depth based on a count of parts that need to be disassembled for viewing the fault location. For example, the processor may determine the count of parts that need to be disassembled for viewing the fault location as the fault concealment depth. The count of parts that need to be disassembled for viewing the fault location and the fault concealment depth may be positively correlated.

The gas flow rate is a volume of gas flowing through the inspection device per unit of time. In some embodiments, the gas flow rate may be measured by various gas flow meters.

In some embodiments, the processor may determine weights of the plurality of inspection devices based on the fault concealment depth and the gas flow rate, and determine the inspection accuracy based on the weights of the plurality of inspection devices, the inspection fault data, and the operation fault data. In some embodiments, the processor may calculate the inspection accuracy by a following formula (1):

$$P = {\sum }_{i = 1}^{n} {a}_{i} {D}_{i} \qquad ( 1 )$$

where P denotes the inspection accuracy; a; denotes the weight of an i-th inspection device; Dᵢ denotes a compliance degree between inspection fault data and operation fault data of the i-th inspection device; and n denotes the total count of inspection devices.

In some embodiments, the weight of the inspection device is positively correlated with the fault concealment depth and the gas flow rate. For an inspection device with a higher fault concealment depth, if the inspector can judge it more accurately, it indicates that the inspector is more familiar with this type of inspection device, and thus a weight of the inspection device may be increased to improve the inspection accuracy, and for an inspection device with a higher gas flow rate, it is possible to increase a weight of the inspection device to improve its importance. In some embodiments, the processor may determine the weight of the inspection device based on the fault concealment depth and the gas flow rate by querying a tenth preset table. The tenth preset table includes a correspondence between the fault concealment depth, the gas flow rate, and the weight of the inspection device, and the tenth preset table may be determined based on historical experience.

In some embodiments of the present disclosure, when determining the inspection accuracy, by taking into account the fault concealment depth and the gas flow rate, an accurate inspection accuracy may be determined, so that a working level of the inspector can be accurately assessed and timely adjusted accordingly, improving the inspection effect.

Some embodiments of the present disclosure, by determining the operation fault data of the inspection device through the abnormality judgment model, and by performing a weighted process based on the inspection fault data and the operation fault data of the plurality of inspection devices, an accurate inspection accuracy can be determined, which helps the inspector to find faults and ensures the normal and safe operation of the gas pipeline network.

The embodiments in the present disclosure are intended to be exemplary and illustrative only and do not limit the scope of application of the present disclosure. To those skilled in the art, various amendments and changes that may be made under the guidance of the present disclosure remain within the scope of the present disclosure.

FIG. 4 is a flowchart illustrating an exemplary process for determining a task assignment parameter according to some embodiments of the present disclosure. As shown in FIG. 4, a process 400 includes the following steps. In some embodiments, the process 400 may be executed by a processor of a gas company management platform.

Step 410, generating at least one group of candidate assignment parameters based on a to-be-assigned inspection device and a matching degree set. Detailed descriptions of the matching degree set may be referred to relevant descriptions of FIG. 2.

The to-be-assigned inspection device is an inspection device that needs to be assigned to an inspector for inspection.

The candidate assignment parameter is an optional assignment manner for an inspection task. The candidate assignment parameter may include inspectors assigned to each to-be-assigned inspection device.

In some embodiments, the processor may sort inspection matching degrees of each inspector for a type of inspection device in descending order, and assign inspectors ranked in the top n places, to the type of inspection device in accordance with an allocation ratio, thereby determining at least one group of candidate assignment parameters. n is a positive integer. Detailed descriptions of obtaining the task assignment parameter may be referred to relevant descriptions of FIG. 2.

Step 420, predicting an inspection score of the at least one group of candidate assignment parameters based on the at least one group of candidate assignment parameters.

The inspection score is a parameter that characterizes the evaluation of the candidate assignment parameter. The higher the inspection score, the more likely its corresponding candidate assignment parameter is used as the task assignment parameter. In some embodiments, the processor may determine the inspection score based on an overall matching degree. The processor may calculate an overall matching degree for all to-be-assigned inspection devices, based on the inspection matching degree of the inspector for each type of inspection device, and determine the overall matching degree as the inspection score.

The overall matching degree is an overall situation of an inspection matching degree between each inspector and inspection devices assigned. In some embodiments, the overall matching degree may be an aggregate of inspection matching degrees between the each inspector and the inspection devices assigned. For example, if an inspector A is assigned an inspection device A and an inspection device B, and an inspector B is assigned the inspection device A and an inspection device C, the overall matching degree is the sum of an inspection matching degree between the inspector A and the inspection device A, an inspection matching degree between the inspector A and the inspection device B, an inspection matching degree between the inspector B and the inspection device A, and an inspection matching degree between the inspector B and the inspection device C.

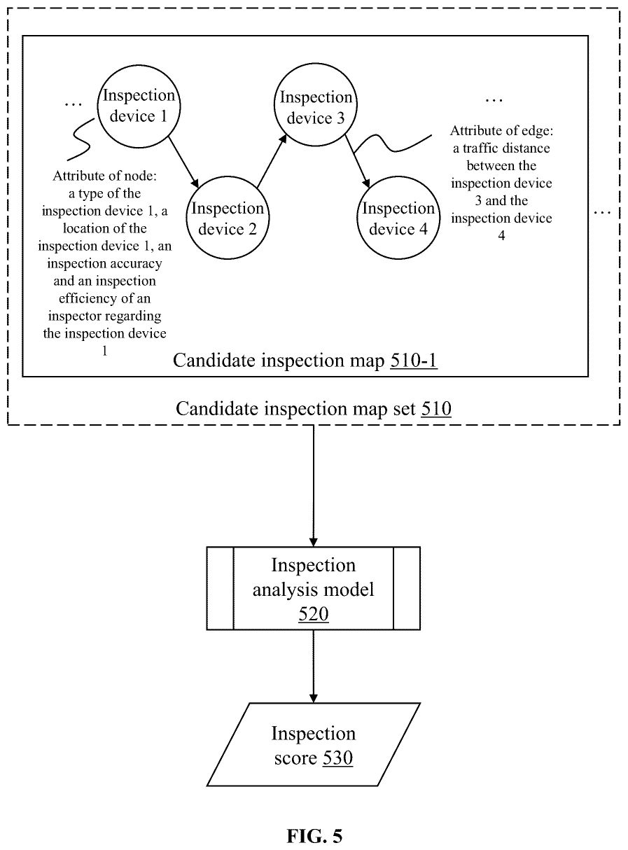

In some embodiments, the processor may determine the inspection score based on a candidate inspection map set using an inspection analysis model, and a detailed description can be found in FIG. 5 and its correlations.

Step 430, determining a target assignment parameter by performing at least one round of iterative updates based on the inspection score until an iteration completion condition is satisfied.

The target assignment parameter is how the inspection task is assigned finally.

In some embodiments, the processor may generate a candidate assignment parameter set, perform at least one round of iterative updates to the candidate assignment parameter set based on the inspection score, and determine the target assignment parameter until the iteration completion condition is satisfied. For example, the processor may determine the target assignment parameter by steps S1 to S4.

The candidate assignment parameter set includes at least one group of candidate assignment parameters.

Step S1: generating at least one new group of candidate assignment parameters, and adding the at least one new group of candidate assignment parameters to the candidate assignment parameter set.

In some embodiments, the processor may select the candidate assignment parameter in the candidate assignment parameter set based on the inspection score. The higher the inspection score, the higher the probability of being selected.

In some embodiments, the processor pairs the candidate assignment parameter in the candidate assignment parameter set two-by-two (e.g., randomly) and performs a crossover operation on two paired candidate assignment parameters to obtain two new candidate assignment parameters. The crossover operation refers to exchanging inspection devices corresponding to candidate assignment parameters that are paired with each other to generate two new candidate assignment parameters.

Step S2: calculating an inspection score of a new candidate assignment parameter.

In some embodiments, the processor may calculate an inspection score corresponding to the candidate assignment parameter in the candidate assignment parameter set. Detailed descriptions of calculating the inspection score may be found in step 420 and the related descriptions thereof.

Step S3: selecting the candidate assignment parameter and determining an updated candidate assignment parameter set.

In some embodiments, the processor may sort candidate assignment parameters in the candidate assignment parameter set according to inspection scores corresponding to the candidate assignment parameters in ascending order, and eliminate candidate assignment parameters starting from the bottom until a total count of candidate assignment parameters in the updated candidate assignment parameter set is the same as an original candidate assignment parameter set.

Step S4: determining whether the iteration completion condition is satisfied.

The iteration completion condition is a condition used to determine whether the iterative update is complete. For example, a count of iterations reaches the maximum value, there is a candidate assignment parameter for which the inspection score satisfies a scoring threshold, or the like. The scoring threshold may be set artificially.

In some embodiments, in response to determining the iteration completion condition is satisfied, the processor may determine the target assignment parameter by performing step S5. In some embodiments, in response to determining the iteration completion condition is not satisfied, the processor may continue with steps S1 to S4.

S5: determining the target assignment parameter.

In some embodiments, in response to determining the iteration completion condition is satisfied, the iterative update ends, and the processor may determine a candidate assignment parameter with a highest inspection score as the target assignment parameter.

Step 440, determining a task assignment parameter based on the target assignment parameter.

In some embodiments, the processor may obtain an inspection device assigned to each inspector based on the target assignment parameter, which in turn determines a task assignment parameter for each inspector.

In some embodiments of the present disclosure, the processor determines an optimal candidate assignment parameter by iteratively optimizing the candidate assignment parameter set, which allows the processor to search for an optimal candidate assignment parameter set globally, avoiding that candidate assignment parameters in the optimal candidate assignment parameter set tend to be locally optimal, and determines the target assignment parameter based on the optimal candidate assignment parameter set, and then obtains the most suitable target assignment parameter.

FIG. 5 is a schematic diagram illustrating determining an inspection score using an inspection analysis model according to some embodiments of the present disclosure.

In some embodiments, for a group of candidate assignment parameters, a processor may construct a candidate inspection map set 510 based on the candidate assignment parameter, and a count of an inspector is a plurality. The candidate inspection map set 510 including a plurality of candidate inspection maps 510-1 corresponding to a plurality of inspectors, and an inspection score 530 is determined based on the candidate inspection map set 510 using an inspection analysis model 520.

Detailed descriptions of the candidate assignment parameter and the inspection score 530 may be referred to relevant descriptions of FIG. 4.

The candidate inspection map set 510 includes candidate inspection maps 510-1 corresponding to the plurality of inspectors. In some embodiments, the processor may construct the candidate inspection maps 510-1 corresponding to the plurality of inspectors based on a candidate assignment parameter.

The candidate inspection map 510-1 refers to a directed map used to represent the association relationships between inspection devices. As shown in FIG. 5, the candidate inspection map 510-1 may include a plurality of inspection devices as well as other features. The candidate inspection map 510-1 may include nodes and edges.

In some embodiments, the nodes include inspection devices corresponding to the inspectors. In some embodiments, an attribute of each of the nodes includes a type of an inspection device, a location of the inspection device, an inspection accuracy and an inspection efficiency of an inspector regarding the inspection device. Detailed descriptions of the inspection device, the inspector, the inspection accuracy and the inspection efficiency may be referred to relevant descriptions of FIG. 2.

In some embodiments, the edges may be directed edges. In some embodiments, the edges include connection lines between two neighboring nodes on an inspection path.

In some embodiments, an attribute of each of the edges includes a traffic distance between two nodes corresponding to the edge.

In some embodiments, a direction of the edge is determined based on an inspection order of the inspection path. In some embodiments, the inspection order may be automatically generated by a computer in accordance with the shortest path principle. For example, an inspection device 1 pointing to a directed edge of an inspection device 2, as shown in FIG. 5, indicates that an inspection order is to inspect the inspection device 1 first and then inspect the inspection device 2.

Understandably, association relationships between a plurality of inspection devices inspected by the inspector may affect the accuracy of the inspection score. For example, the inspector, after inspecting a plurality of inspection devices of the same type, may find more problems based on shared features or in combination with experience, resulting in a higher inspection accuracy than an inspection accuracy determined earlier. As another example, after inspecting the plurality of inspection devices of the same type, the inspector may be influenced by previous inspection devices, leading to a misdiagnosis of later inspection devices, which may lead to a lower inspection accuracy. Therefore, it would be more accurate to construct the inspection analysis map set and carry out prediction with a model.

The inspection analysis model 520 is a model used to determine the inspection score 530. The inspection analysis model 520 is a machine learning model. For example, a Graph Neural Network (GNN) model, or the like.

In some embodiments, inputs to the inspection analysis model 520 may include the candidate inspection map set 510 and an output may include the inspection score 530.

In some embodiments, the processor may train and obtain the inspection analysis model 520 with a large number of third samples with a third label. The third sample may be a sample candidate inspection map set constructed based on historical data. The third label may be an inspection score corresponding to the actual completion effect of an inspection device in the sample candidate inspection map set.

The actual completion effect is the actual completion of the inspection task by the inspector after the inspection device is assigned to the inspector according to the candidate assignment parameter. The actual completion effect may include a count of unrecognized faults that occurred in a third preset period after the inspector actually completed the inspection task and the time taken to complete all inspection tasks. The unrecognized fault is a fault that was not found by the inspector during an inspection. The third preset period may be preset manually. In some embodiments, the processor may perform a weighted calculation on the count of unrecognized faults and the time taken by the inspector to complete all the inspection tasks, determine a calculation result as the inspection score, and determine the inspection score as the second label.

In some embodiments, the processor may input the third sample into an initial inspection analysis model, construct a loss function based on an output of the initial inspection analysis model with the third label, and based on the loss function, update parameters of the initial inspection analysis model. When the loss function of the initial inspection analysis model satisfies a preset condition, a model training is completed and a trained inspection analysis model is obtained. The preset condition may be that the loss function converges, a count of iterations reaches a threshold, or the like.

Some embodiments of the present disclosure utilize the inspection analysis model to determine the inspection score, which may improve the accuracy and efficiency of an output result; and by using the candidate inspection map, association relationships between the plurality of inspection devices may be represented, improving the accuracy of a predicted inspection score.

Some embodiments of the present disclosure provide a computer-readable storage medium, the storage medium storing computer instructions, and when a computer reads the computer instructions in the storage medium, the computer executes a method for smart gas inspection supervision as described above.

In addition, certain features, structures, or characteristics of one or more embodiments of the present disclosure may be suitably combined.

In the event of any inconsistency or conflict between the descriptions, definitions, and/or use of terms in the materials cited in the present disclosure and those described in the present disclosure, the descriptions, definitions, and/or use of terms in the present disclosure shall prevail.

What is claimed is:

1. A method for smart gas inspection supervision, wherein the method is executed by a processor of a gas company management platform of an Internet of Things (IoT) system for smart gas inspection supervision, the method comprising:
collecting inspection record data based on a gas company inspector object platform, the inspection record data being stored in a data storage center of the gas company management platform;
obtaining operation data of at least one inspection device based on a gas company device object platform, the operation data being stored in the data storage center of the gas company management platform, and the at least one inspection device including at least one type of the inspection device;
for a type of inspection device, evaluating an inspection matching degree between an inspector and the inspection device based on the inspection record data and the operation data;
determining a task assignment parameter and a training parameter for the inspector based on a matching degree set, the matching degree set including the inspection matching degree between the inspector and the at least one type of inspection device;
adjusting a first acquisition ratio of the inspection record data by the gas company inspector object platform, and a second acquisition ratio of the operation data by the gas company device object platform based on the task assignment parameter and the training parameter;
sending a result of task execution of the inspector to a government supervision management platform;
evaluating inspection quality of different gas companies by the government supervision management platform based on the result of task execution, and adjusting, based on the inspection quality, an inspection supervision parameter of the government supervision management platform for the different gas companies, a gas collection frequency of a gas sensor device, and a gas upload frequency of the gas sensor device; and
generating an adjustment instruction based on an adjustment amount of the gas collection frequency and an adjustment amount of the gas upload frequency, and sending the adjustment instruction to the gas sensor device.

2. The method of claim 1, wherein for a type of inspection device, evaluating an inspection matching degree between an inspector and the inspection device based on the inspection record data and the operation data includes:
evaluating an inspection accuracy of the inspector regarding the inspection device based on the inspection record data and the operation data; and
determining the inspection matching degree based on the inspection accuracy and an accuracy threshold of the inspection device.

3. The method of claim 2, wherein the evaluating an inspection accuracy of the inspector regarding the inspection device based on the inspection record data and the operation data includes:
obtaining inspection fault data of the inspection device based on the inspection record data;
obtaining abnormal operation data based on the operation data;
determining operation fault data of the inspection device based on the anomalous operation data using an abnormality judgment model, the abnormality judgment model being a machine learning model; and
determining the inspection accuracy based on the inspection fault data and the operation fault data.

4. The method of claim 3, wherein a count of the inspection device is a plurality, and the inspection accuracy is further related to a fault concealment depth and a gas flow rate of the plurality of inspection devices; and the determining the inspection accuracy based on the inspection fault data and the operation fault data includes:
determining weights of the plurality of inspection devices based on the fault concealment depth and the gas flow rate; and
determining the inspection accuracy based on the weights of the plurality of inspection devices, the inspection fault data, and the operation fault data.

5. The method of claim 2, wherein a count of the inspection device is a plurality, and the determining the inspection matching degree based on the inspection accuracy and an accuracy threshold of the inspection device includes:
determining, based on the inspection record data, a distribution of inspection durations of the inspector on the plurality of inspection devices;
determining an inspection efficiency based on the distribution of inspection durations; and
determining the inspection matching degree based on the inspection efficiency and the inspection accuracy.

6. The method of claim 5, wherein the inspection efficiency is further related to a distribution of inspection devices and the inspection accuracy; the determining an inspection efficiency based on the distribution of inspection durations includes:
determining the inspection efficiency based on the distribution of inspection devices, the distribution of inspection durations, and the inspection accuracy using an efficiency model, the efficiency model being a machine learning model.

7. The method of claim 1, wherein the determining a task assignment parameter and a training parameter for the inspector based on a matching degree set includes:
determining the task assignment parameter based on the matching degree set and a matching degree requirement set; and
determining the training parameter based on the matching degree set and the task assignment parameter, the training parameter including a training duration and a period for completion of training.

8. The method of claim 7, wherein the matching degree requirement set includes a matching degree requirement for each of the at least one inspection device, and determining a matching degree requirement includes:
determining the matching degree requirement based on a gas safety impact degree, a gas usage impact degree, and an accuracy threshold of the at least one inspection devices, the gas safety impact degree being determined based on a location and historical fault impact of the at least one inspection device, and the gas usage impact degree being determined based on a gas flow rate and a count of gas users corresponding to the at least one inspection device.

9. The method of claim 7, wherein the determining the task assignment parameter based on the matching degree set and a matching degree requirement set includes:
generating at least one group of candidate assignment parameters based on a to-be-assigned inspection device and the matching degree set;
predicting an inspection score of the at least one group of candidate assignment parameters based on the at least one group of candidate assignment parameters;
determining a target assignment parameter through performing at least one round of iterative updates based on the inspection score until an iteration completion condition is satisfied; and
determining the task assignment parameter based on the target assignment parameter.

10. The method of claim 9, wherein the predicting an inspection score of the at least one group of candidate assignment parameters based on the at least one group of candidate assignment parameters includes:
for a group of candidate assignment parameters,
constructing a candidate inspection map set based on the candidate assignment parameters, wherein a count of the inspector is a plurality, the candidate inspection map set including a plurality of candidate inspection maps corresponding to the plurality of inspectors;
for an inspector, the candidate inspection map including nodes and edges, the nodes including inspection devices corresponding to the inspectors, an attribute of each of the nodes including a type of the inspection device, a location of the inspection device, an inspection accuracy and an inspection efficiency of the inspector regarding the inspection device, the edges including connecting lines between two neighboring nodes on an inspection path, an attribute of each of the edges including a traffic distance between two nodes corresponding to the edge, a direction of the edge being determined based on an inspection order of the inspection path; and
determining the inspection score based on the candidate inspection map set using an inspection analysis model, the inspection analysis model being a machine learning model.

11. An Internet of Things (IoT) system for smart gas inspection supervision, wherein the IoT system includes a gas company management platform, a gas company sensor network platform, a gas company object platform, a government supervision user platform, a government supervision service platform, a government supervision management platform, a government supervision sensor network platform, and a government supervision object platform, the gas company object platform including a gas company inspector object platform and a gas company device object platform, and the gas company management platform including a data processing sub-platform and a data storage center; and the IoT system is configured to:
collect inspection record data based on the gas company inspector object platform, the inspection record data being stored in the data storage center of the gas company management platform;
obtain operation data of at least one inspection device based on the gas company device object platform, the operation data being stored in the data storage center of the gas company management platform, and the at least one inspection device including at least one type of the inspection device;
for a type of inspection device, evaluate an inspection matching degree between an inspector and the inspection device based on the inspection record data and the operation data;
determine a task assignment parameter and a training parameter for the inspector based on a matching degree set, the matching degree set including an inspection matching degree between the inspector and at least one type of inspection device;
adjust a first acquisition ratio of the inspection record data by the gas company inspector object platform and a second acquisition ratio of the operation data by the gas company device object platform based on the task assignment parameter and the training parameter;
send a result of task execution of the inspector to the government supervision management platform;
evaluate inspection quality of different gas companies by the government supervision management platform based on the result of task execution, and adjust, based on the inspection quality, an inspection supervision parameter of the government supervision management platform for the different gas companies, a gas collection frequency of a gas sensor device, and a gas upload frequency of the gas sensor device; and
generate an adjustment instruction based on an adjustment amount of the gas collection frequency and an adjustment amount of the gas upload frequency, and send the adjustment instruction to the gas sensor device.

12. The IoT system of claim 11, wherein the gas company management platform and the government supervision sensor network platform interact with each other.

13. The IoT system of claim 11, wherein the gas company management platform is configured to:
evaluate an inspection accuracy of the inspector regarding the inspection device based on the inspection record data and the operation data; and
determine the inspection matching degree based on the inspection accuracy and an accuracy threshold of the inspection device.

14. The IoT system of claim 13, wherein the gas company management platform is further configured to:
obtain inspection fault data of the inspection device based on the inspection record data;
obtain abnormal operation data based on the operation data;
determine operation fault data of the inspection device based on the anomalous operation data using an abnormality judgment model, the abnormality judgment model being a machine learning model; and
determine the inspection accuracy based on the inspection fault data and the operation fault data.

15. The IoT system of claim 14, wherein a count of the inspection device is a plurality, the inspection accuracy is further related to a fault concealment depth and a gas flow rate of the plurality of inspection devices; and the gas company management platform is further configured to:
determine weights of the plurality of inspection devices based on the fault concealment depth and the gas flow rate; and
determine the inspection accuracy based on the weights of the plurality of inspection devices, the inspection fault data, and the operation fault data.

16. The IoT system of claim 13, wherein a count of the inspection device is a plurality, and the gas company management platform is further configured to:
determine, based on the inspection record data, a distribution of inspection durations of the inspector on the plurality of inspection devices;
determine an inspection efficiency based on the distribution of inspection durations; and
determine the inspection matching degree based on the inspection efficiency and the inspection accuracy.

17. The IoT system of claim 16, wherein the inspection efficiency is further related to a distribution of inspection devices and the inspection accuracy; and the gas company management platform is further configured to:
determine the inspection efficiency based on the distribution of inspection devices, the distribution of inspection durations, and the inspection accuracy using an efficiency model, the efficiency model being a machine learning model.

18. The IoT system of claim 11, wherein the gas company management platform is further configured to:
determine the task assignment parameter based on the matching degree set and a matching degree requirement set; and
determine the training parameter based on the matching degree set and the task assignment parameter, the training parameter including a training duration and a period for completion of training.

19. The IoT system of claim 11, wherein the matching degree requirement set includes a matching degree requirement for each of the at least one inspection device, and the gas company management platform is further configured to:
determine a matching degree requirement based on a gas safety impact degree, a gas usage impact degree, and an accuracy threshold of the at least one inspection device, the gas safety impact degree being determined based on a location and historical fault impact of the at least one inspection device, and the gas usage impact degree being determined based on a gas flow rate and a count of gas users of the at least one inspection device.

20. A non-transitory computer-readable storage medium, comprising a set of instructions, wherein when a computer reads the computer instructions in the storage medium, the method for smart gas inspection supervision of claim 1 is implemented.
